(19) United States
(12) Patent Application Publication
(10) Pub. No.: US 2002/0033690 A1
(43) Pub. Date: Mar. 21, 2002

(54) Low voltage DC powered telecommunications customer service terminal having optical hot-swappable low voltage battery module

(76) Inventors: Scott Lawrence Karpiel, Bromfield, CO (US); Craig S. Cambier, Louisville, CO (US); James A. Bloemen, Highlands Ranch, CO (US)

Correspondence Address: HOLLAND & HART LLP, PO BOX 8749, 555 17TH STREET, STE 3200, DENVER, CO, 80201, US

(21) Appl. No.: 09/872,382

(22) Filed: Jun. 1, 2001

Related U.S. Application Data
(60) Provisional application No. 60/209,277, filed on Jun. 2, 2000.
(60) Provisional application No. 60/279,910, filed on Mar. 29, 2001.

(51) Int. Cl. H04M 11/00

(52) U.S. Cl. 320/107; 379/93.06; 379/90.01

(57) ABSTRACT

A telecommunications system includes a customer service terminal having a digital signal-input, a low voltage DC power-input that renders the customer service terminal operative in the absence of an on/off switch, a plurality of analog signal-outputs, and at least one digital signal-output. A digital subscriber line is connected to the digital signal-input, a plurality of analog devices are connected to the plurality of analog signal-outputs, a low voltage DC power supply has its high voltage AC input connected to a high voltage AC power line, and the low voltage DC output of the power supply is connected to the low voltage DC power-input of the customer service terminal. A low voltage rechargeable battery forms a manually-removable portion of the low voltage DC power supply. The battery maintains DC power input to the low voltage DC power-input of the customer service terminal upon failure of the high voltage AC line.

This non-provisional patent application claims the benefit of copending provisional patent application serial No. 60/209,277 filed Jun. 2, 2000 and entitled INTEGRATED TELECOMMUNICATIONS ACCESS DEVICE USING SDSL, incorporated herein by reference.

This non-provisional patent application claims the benefit of copending provisional patent application serial No. 60/279,910 filed Mar. 29, 2001 and entitled TELECOMMUNICATIONS CUSTOMER SERVICE TERMINAL, incorporated herein by reference.

### RELATED PATENT APPLICATIONS

Design patent application Ser. No. 29/138,897 filed Mar. 21, 2001 and entitled BACKUP POWER PACK.

Design patent application Ser. No. 29/138,901 filed Mar. 21, 2001 and entitled TELECOMMUNICATIONS CUSTOMER SERVICE TERMINAL.

Non-provisional patent application serial No. xx/xxx,xxx filed May --, 2001 and entitled LOW VOLTAGE DC POWERED TELECOMMUNICATIONS CUSTOMER SERVICE TERMINAL HAVING TELEPHONE WIRE INTERCONNECTION AND A HOT-SWAPPABLE LOW VOLTAGE BATTERY MODULE. (attorney docket number 40405.830021.000)

### FIELD OF THE INVENTION

This invention relates to the field of telecommunications, and more specifically to a telecommunications customer service terminal (CST) (also known as a telecommunications integrated access device or IAD) that is operable to deliver carrier-class analog voice and digital data to a telephone user such as a home or a small business.

### BACKGROUND OF THE INVENTION

The use of telecommunications customer service terminals or integrated access devices is known. However, there is a need in the art for a small, simple and inexpensive device that provides both analog voice and digital data to relatively small-telecommunications-need telephone users wherein uninterrupted service is provided by providing a hot-swappable battery pack that is within a low voltage battery module.

It is known that in devices such as electronic timepieces that are wall-connected to high voltage alternating current (AC), a low voltage battery has been provided to bridge momentary power failure of the AC input, that an indicator has been provided to indicate the need to replace this low voltage battery, and that, so long as the AC input remains active, the low voltage battery can be replaced without interrupting operation of the timepiece. That is, the low voltage battery can be “hot swapped”.

### SUMMARY OF THE INVENTION

This invention provides a small, simple and inexpensive single-line-entry telecommunications CST that is powered by low voltage direct current (DC) in the absence of an on/off switch. That is, so long as the CST is provided with a low voltage DC input, the CST remains operative and it is only the absence of the low voltage Dc input that causes the CST to become inactive.

So long as high voltage AC input power remains available to an AC-to-DC converter, the CST receives low voltage DC input power from the low voltage DC output of the converter, and the CST remains operative. Should the high voltage AC power fail, a hot-swappable low voltage battery module provides low voltage DC power to the CST.

The CST does not have an on/off switch. In the event of an extended period of AC power failure, for example an eight hour AC power failure, the currently-in-use low voltage battery may become discharged or relatively discharged. In this case, the old battery pack can be swapped for a freshly charged battery pack, whereupon the CST will experience only a short time period of inoperativeness, during which time period this battery pack swapping takes place.

Since most telephone installation service trucks carry quantities of relatively inexpensive 24, 26 and 28 gage telephone wire, it is desirable that this available telephone wire be used to connect the CST to its low voltage DC input power, to an input telecommunications line, and to the various telephones and data terminals that are serviced by the analog/digital outputs of the CST.

Low voltage DC input power is optionally supplied to the CST by selecting for use, during installation of the CST, either (1) a first type of power supply whose input is a high voltage AC (for example 110 VAC) and whose output is a low voltage DC (for example 24 VDC), or (2) a second type of battery pack power supply module whose input is a high voltage AC (for example 110 VAC), whose output is a low voltage DC (for example 24 VDC), and which includes a manually removable DC battery pack that operates to supply low voltage DC power to the CST when the high voltage AC input to this second type of power supply fails. By way of example, the battery pack supplies up to eight hours of backup low voltage DC power to bridge an eight hour failure of the high voltage AC.

This second type of power supply includes circuitry that is operable to monitor the state of charge of the manually removable DC battery pack, as well as circuitry that is operable to monitor the active/inactive state of the high voltage AC input to the power supply.

A first indicator, such as a light emitting diode (LED), is provided on the housing of this second type of power supply to indicate the state of charge of its DC battery pack. A second indicator is provided on the housing of this second type of power supply to indicate that the power supply's high voltage AC input is active or inactive.

This second type of power supply is constructed and arranged such that, so long as the high voltage AC applied thereto is active, manual removal and replacement of the DC battery pack does not disturb the supply of low voltage DC power to the CST, i.e. the battery pack can be “hot swapped”.

In the event of a long period of AC power failure to this second type of power supply, and since the CST does not include an on/off switch, a DC battery pack whose charge has become depleted due to AC power failure can be replaced with a freshly charge DC battery pack during the period of AC power failure, and the CSR experiences only a short time period of inoperability, during which short time period battery pack replacement takes place.

Since all wiring to and from the CST carries low voltage, readily available and low cost American Wire Gage (AWG) telephone wire can be used to connect low voltage DC operating voltage to the CST, to connect a symmetrical digital subscriber line (generically a digital subscriber line) to an input terminal of the CST, and to connect the CST's various output terminals to analog telephones and digital data terminals.

### BRIEF DESCRIPTION OF THE DRAWING

FIG. 1 shows a telecommunications system that embodies the invention.

FIG. 2 is a perspective view showing FIG. 1's battery pack power supply.

FIG. 3 is an exploded view of the FIG. 2 battery pack power supply wherein the battery pack has been manually removed from the power supply's base member.

FIG. 4 shows another telecommunications system that embodies the invention.

FIG. 5 is a block-diagram showing of the battery pack power supply shown in FIG. 1.

FIG. 6 is a circuit diagram of FIG. 5's AC-to-DC rectification network.

FIG. 7 is a circuit diagram showing of FIG. 5's pulse width modulating DC-to-DC converter, current control loop, and voltage control loop.

FIG. 8 is a circuit diagram showing of FIG. 5's battery charge/discharge network.

### DETAILED DESCRIPTION OF THE INVENTION

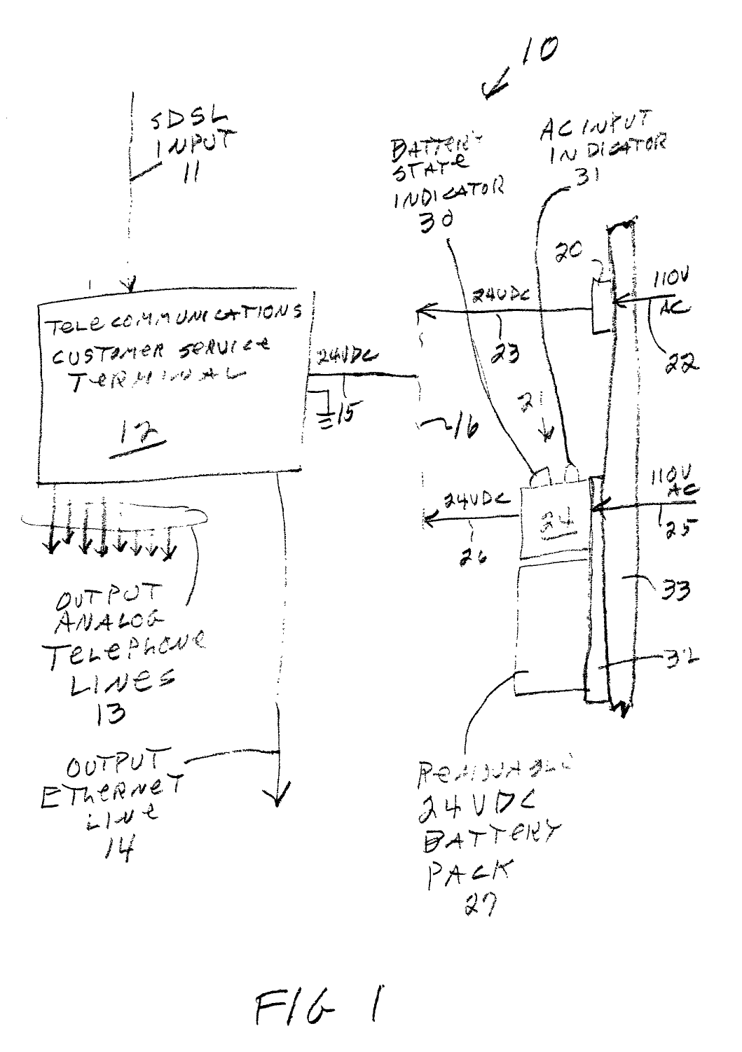

FIG. 1 shows a single-line-input telecommunications system 10 that includes a low voltage DC battery pack power supply 21 having a rechargeable low voltage battery 27 in accordance with this invention.

Telecommunications-input to system 10 is provided by way of a symmetrical digital subscriber line (SDSL) 11. CST 12 is a scalable integrated access device (AID) that provides integrated voice and data services to a customer's premises over SDSL 11.

CST 12 operates upon SDSL telephone wire input 11 to provide a plurality of analog telephone wire outputs 13 that are adapted to be connected to a like plurality of telephone terminals (not shown). CST 12 also operates upon input 11 to provide at least one digital Ethernet telephone wire output 14 to at least one digital data terminal (not shown).

As is known, SDSL 11 is a type of digital subscriber line (DSL) that is similar to high-bit-rate HDSL wherein a single twisted-pair line carries 1.544 Mbps (U.S. and Canada) or 2.048 Mbps (Europe) in each direction on a duplex line that is symmetric because the data-rate is the same in both directions.

DSL is a technology for bringing high-bandwidth information to homes and small businesses over ordinary copper telephone lines, wherein xDSL refers to different variations of DSL, such as, but not limited to, ADSL, CDSL, HDSL, IDSL, RADSL, SDLS, UDSL and VDSL. A DSL can carry both data and voice-signals, wherein the data part of the line is continuously connected.

Assuming that the home or small business is close enough to a telephone company central office that offers DSL, the home or small business may be able to receive data at rates up to 6.1 megabits per second, thus enabling continuous transmission of motion picture video, audio, and even 3-dimensional effects.

While telecommunications system 10 will be described as having a SDSL input 11, its spirit and scope includes virtually any type of DSL input.

Grounded low voltage 24 VDC input power is applied to CST 12 by telephone wire 15. As shown by dotted line 16, this 24 VDC input power is optionally supplied by a first power supply 20 or a second battery pack power supply 21.

Power supply 20 is of a type that receives a high voltage AC input 22, such as 110 VAC, and operates to supply a low voltage DC output, such as 24 VDC, on telephone wire 23.

Battery pack power supply 21 includes a component 24 that operates similar to power supply 20. That is, so long as 110 VAC input 25 to power supply 24 remains active, 24 VDC telephone wire output 26 of component 24 remains active. In addition, battery pack power supply 21 includes a manually replaceable 24 VDC battery pack 27 that constitutes an eight-hour backup power supply for component 24.

Circuitry within component 24 operates to activate a battery-state indicator 30 in accordance with the state of charge of 24 VDC battery pack 27, and operates to activate another indicator 31 in accordance with the active/inactive state of 110 VAC input 25.

Power supply 21 is constructed and arranged so that when indicator 30 indicates the state of charge of the 24 VDC battery pack 27 that is currently resident on base member 32. When indicator 31 also indicates that 110 VAC input 25 is active, that particular battery pack 27 can be removed and replaced with a fully charged battery pack 27 without interrupting the operation of CST 12. That is, so long as 110 VAC input 25 to battery pack power supply 21 remains active, this removal and replacement of battery packs 27 does not interrupt the operation of CST 12.

In this construction and arrangement of telecommunications system 10, all wiring, with the exception of 110 VDC inputs 22 and 25, is American Wire Gage telephone wiring that is readily available to telecommunications workers who are building or connecting system 10, for example 24, 26 or 28 gage telephone wire of the type that is usually found in telephone installation trucks.

CST 12 and power supply 20 or power supply 21 are adapted to be mounted in relatively close proximity to each other, for example on a vertical wall 33. Optionally the housing of CST 12 can be constructed and arranged for mounting out of doors.

CST 12 does not have an on/off switch. As a result, only the continuous present of low voltage DC input 15 is required to maintain CST 12 continuously operative. Should AC power input 25 to battery pack power supply 21 fail for a relatively long time interval, for example for eight hours, the currently-in-use DC battery pack 27 may have to be replaced with a freshly charged DC battery pack 27. In this event, CST 12 experiences only a short period of inoperativeness while the old battery pack 27 is manually removed from base member 32 and a freshly charged battery pack 27 is manually inserted onto base member 32.

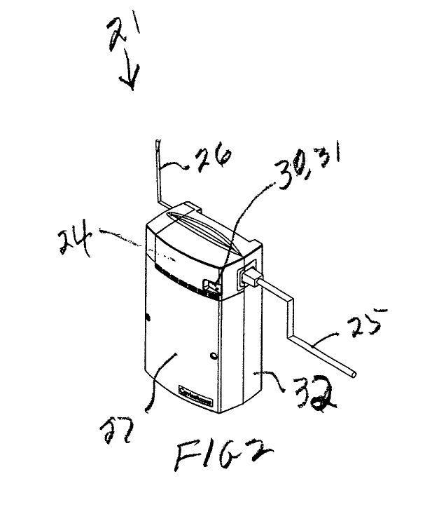

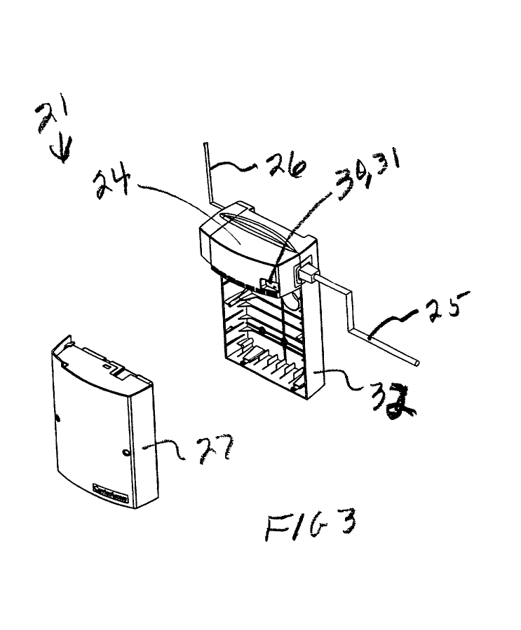

FIG. 2 provides a perspective view that shows FIG. 1's battery pack power supply 21. FIG. 3 is an exploded view of FIG. 2's battery pack power supply 21 wherein rechargeable low voltage battery pack 27 has been manually removed from the power supply's base member 32.

As shown, base member 32 supports 110 VDC-to-24 VDC power supply 24 at its upper portion, the housing for power supply 24 provides a mounting position for indicators 30,31, and one end of 110 VAC input line 25 plugs into supply 24.

As above-described, 24 VDC power on telephone wire 26, i.e. low voltage DC input power to CST 12, is not interrupted when battery pack 27 is removed, so long as 110 VAC power 25 is available to power supply 21, i.e. battery pack 27 can be “hot swapped” without disturbing the operation of CST 12. When a fully-charged battery pack 27 is in place on base 32, 24 VDC input power 26 remains available to CST 12 for a relatively long time period of about eight hours during which 110 VAC power 25 is not available to power supply 21.

As will be apparent, component 24 of power supply 21 operates to charge battery pack 27 whenever AC input 25 is active. Thus, while short periods of interruption of AC input 25 will somewhat discharge battery pack 27, battery pack 27 is usually recharged by operation of component 24 when AC input 25 restores. If a long period of AC power failure is experienced, and as a result battery pack 27 becomes nearly discharged (as is indicated by a red-light output from FIG. 1's battery state indicator 30), a new and fully charged battery pack 27 can be inserted into power supply, with only a short period of inoperability of CST 12 being experienced as battery packs are swapped.

In an embodiment of the invention, power supply 21 was about 11.75 inches high, about 7.5 inches wide, and about 4.625 inches deep. The rechargeable battery pack 27 of such a power supply was about 9.1 inches high, about 7.5 inches wide, and about 3.5 inches deep.

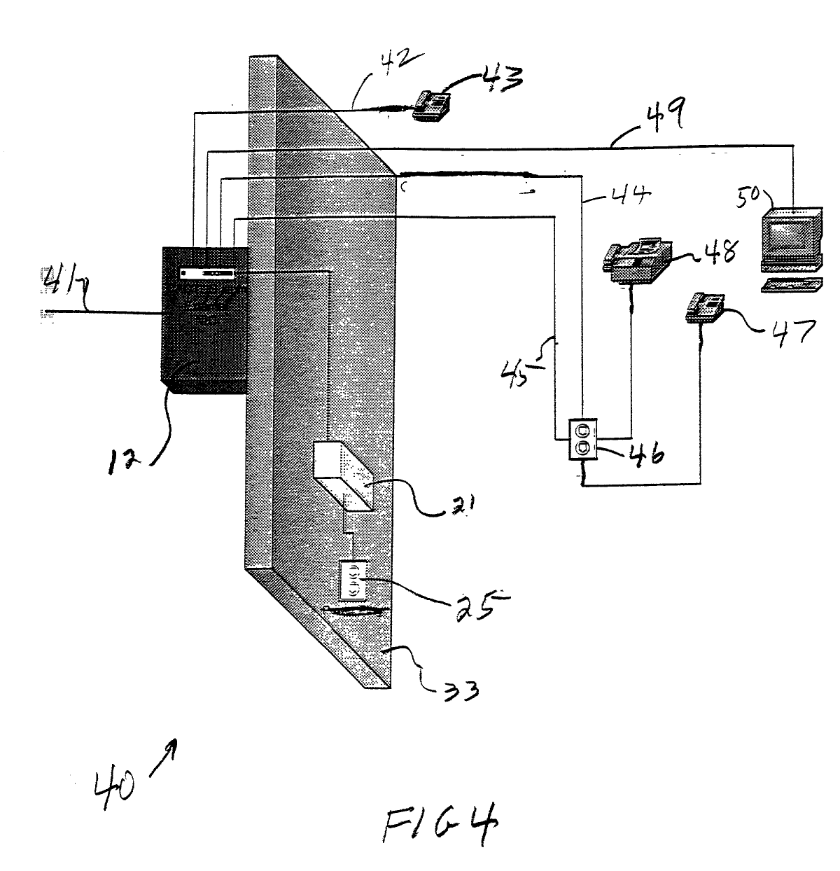

FIG. 4 shows another telecommunications system 40 that embodies the invention. System 40 is provided with only one low voltage DC power supply, i.e. above-described low voltage DC power supply 21 having a rechargeable low voltage DC battery 27, wherein low voltage DC power supply 21 receives its primary-power from a high voltage AC power plug 25, and wherein low voltage DC power supply 21 receives its backup power, as is needed, from its rechargeable low voltage DC battery 27, as above-described.

System 40 receives a digital telecommunications-input by way of a single-pair, telephone-wire xDSL line 41. In system 40, a first analog signal-output 42 of CST 12 is telephone-wire connected to a residential telephone terminal 43, a second analog signal-output 44 and a third analog signal-output 45 of CST 12 are telephone-wire connected to a phone jack 46 which is then telephone-wire connected to a second office telephone terminal 47 and to a facsimile device 48, and a digital signal-output 49 of CST 12 is a 10/100BaseT Ethernet output that is telephone-wire connected to personnel computer 50.

In system 40, the rechargeable DC battery pack 27 that is a manually replaceable portion of low voltage DC power supply 21 again provides up to eight hours of uninterrupted power protection for CST 21 against a failure of high voltage AC input 25.

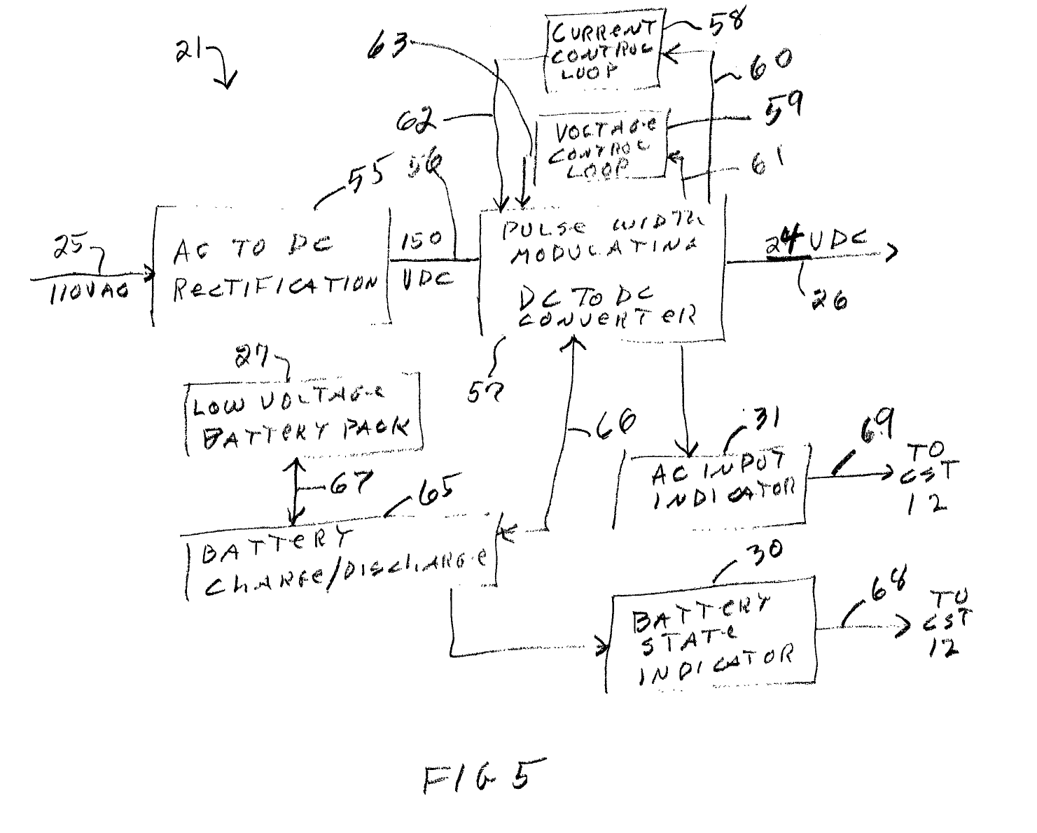

FIG. 5 is a block-diagram showing of battery pack power supply 21. High voltage AC input 25 is applied to an AC-to-DC rectification network 55 whose output 56 is 150 volts DC.

This 150 VDC output 56 is connected as an input to a pulse width modulating (PWM) DC-to-DC converter network 57 whose output is the 24 VDC output 26 of battery pack power supply 21.

Output 26 is maintained at 24 VDC by the operation of a current control loop 58 and a voltage control loop whose inputs 60 and 61 respectively respond to the current flow in telephone wire 26 and to the voltage on telephone wire 26, and whose outputs 62 and 63 operate to control the pulse width modulation on/off operation of DC-to-DC converter 57 so as to supply CST 12 with its required current at a constant and stable 24 VDC. That is, the pulse width modulation on/off operation of DC-to-DC converter 57 is controlled in accordance with the low voltage DC power-input needs of CST 12.

DC-to-DC converter 57 is also connected to a battery charge/discharge network 65 by way of a connection 66, and battery charge/discharge network 65 is connected to battery pack 27 by way of a connection 67.

When high voltage AC input 25 fails, battery charge/discharge network 65 operates in its discharge-mode as connections 67 and 66 apply the battery's 24 VDC to DC-to-DC converter 57 and then to CST 12 by way of telephone wire 26.

When high voltage AC input 25 is subsequently restored, battery charge/discharge network 65 operates in its charge-mode as connections 66 and 67 apply a recharging voltage that originates at DC-to-DC converter 57 to battery pack 27, and as DC-to-DC converter then operates to apply 24 VDC to CST 12 by way of telephone wire 26.

In an embodiment of the invention, AC input indicator 31 operated such that a green-light output indicated that AC input 25 was active, and such that a no-light-output indicated that AC input 25 was inactive.

In this embodiment, battery state indicator 30 operated such that a green-light output indicated that battery pack 27 was charging, a yellow-light output indicated that battery pack 27 was discharging and its output voltage was at or above 21 VDC, a red-light output indicated that battery pack 27 was discharging and its output voltage was in the range of from 18 VDC to less than 21 VDC, and a no-light-output indicated that battery pack 27 was inoperative, i.e. battery pack 27 was not present on base member 32 or its output voltage was less than 18 VDC.

As is indicated by telephone wires 68 and 69, it may be desirable to repeat the operation of indicators 30 and 31 at CST 12.

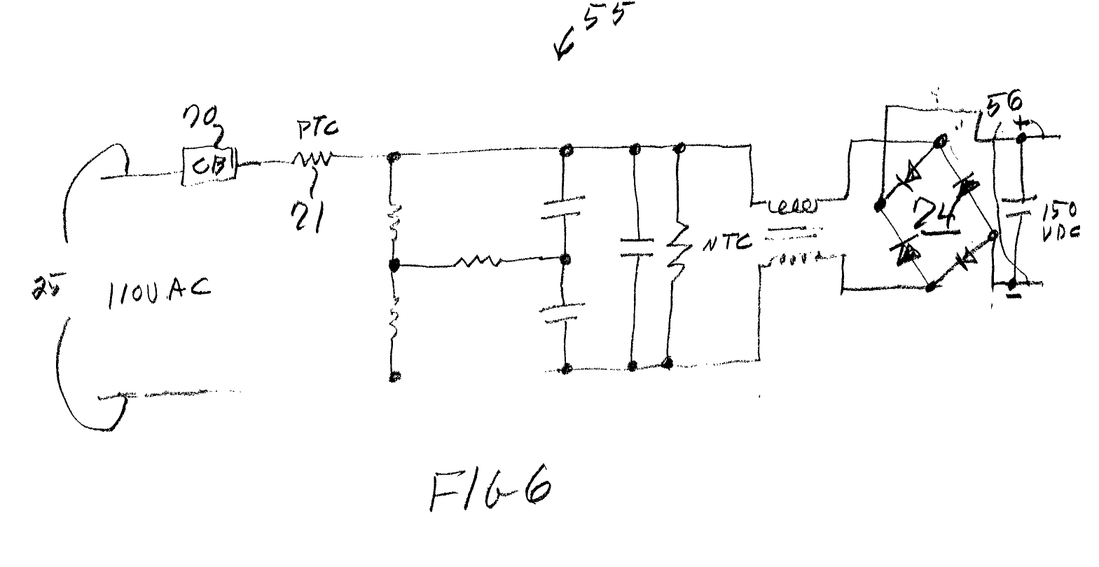

FIG. 6 is a circuit diagram showing of FIG. 5's AC-to-DC rectification network 55. This network includes a circuit breaker (CB) 70, a positive temperature coefficient (PTC) resistor 71, a negative temperature coefficient (NTC) resistor 73, and a rectifier bridge circuit 74 that operate to convert 110 VAC input 25 to a 150 VDC output 56.

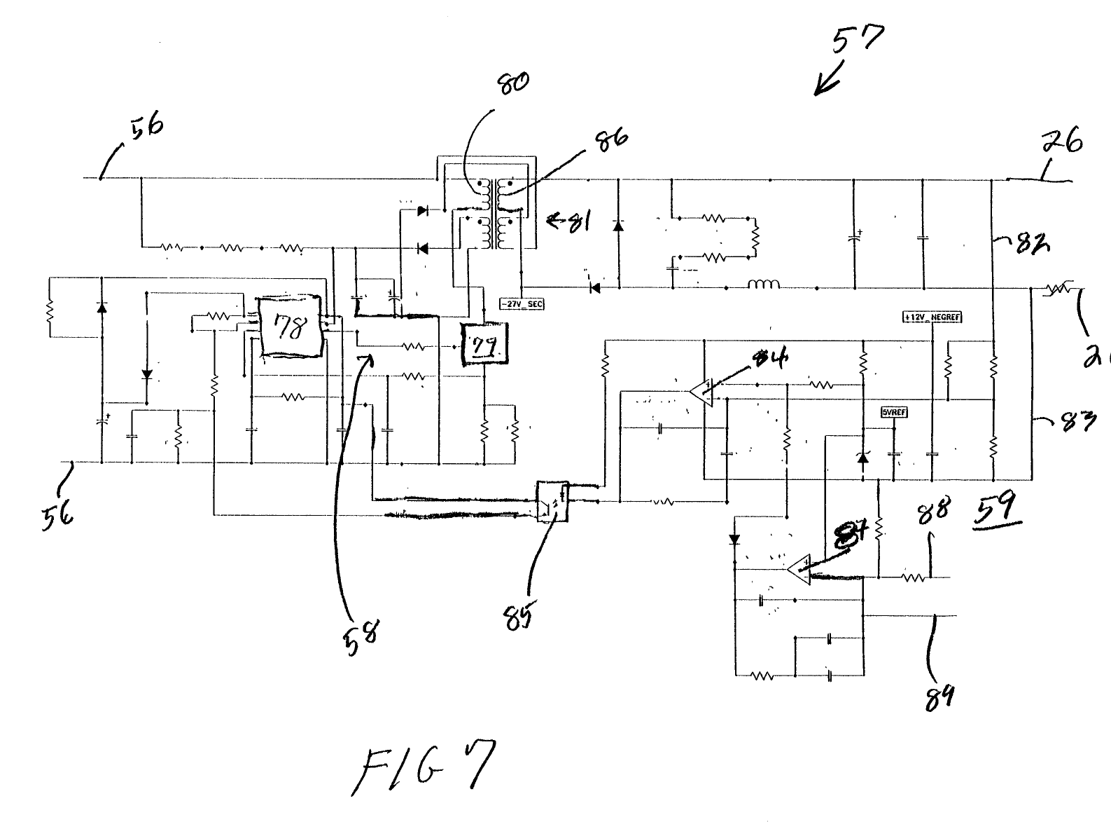

FIG. 7 is a circuit diagram showing of FIG. 5's pulse width modulating DC-to-DC converter 57. The FIG. 7 circuit diagram also includes both current control loop 58 and voltage control loop 59.

The 150 DVC output of AC-to-DC rectification network 55 is applied as an input at conductors 56 of FIG. 7, and the 24 VDC output appears at conductors 26 that connect to coil 86 of transformer 81. A pulse width modulator chip 78 controls a switching MOSFET 79 in a manner to control the current flow through the winding 80 of a four-coil transformer 81. Voltage control loop 59 includes two conductors 82 and 83 that are connected to 24 VDC conductors 26, and two op-amps 84 and 87. The output of op amp 84 is connected as an input to an optical isolator 85 and then to pulse width modulator chip 78.

Current control loop 58 responds to the current flow through switching MOSFET 79 and also operates to provide an input to pulse width modulator chip 78.

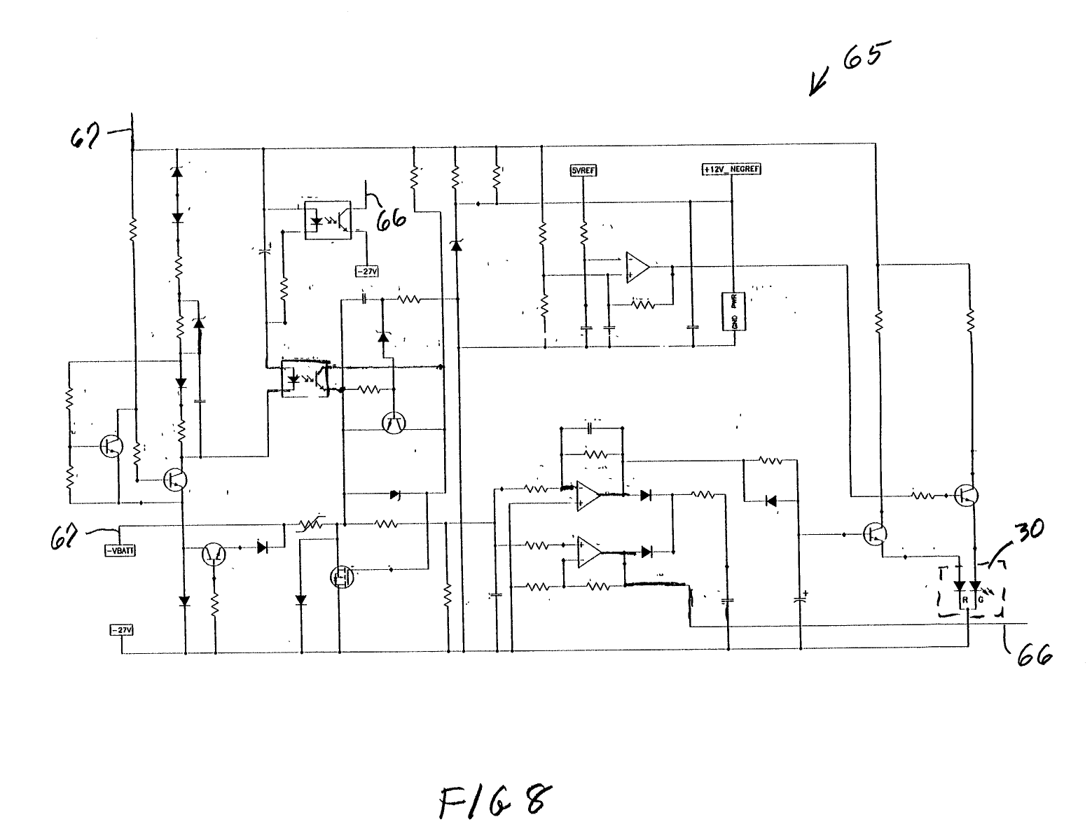

FIG. 8 is a circuit diagram showing of FIG. 5's battery charge/discharge network 65. Battery charge/discharge network 65 is connected to low voltage rechargeable battery pack by way of a connection 67, and it is connected to pulse width modulating DC-to-DC converter by way of a connection 66. Note that both of the connections 66 and 67 are bi-directional connections.

When high voltage AC line 25 to AC-to-DC rectification network 55 is active, the 150 VDC output of AC-to-DC rectification network 55 is active, and pulse width modulating DC-to-DC converter operates to maintain CST 12 operative by way of its 24 VDC output 26. At the same time, bi-directional connection 66, battery charge/discharge network65, and bi-directional connection 67 operate to charge low voltage battery 27, if such a charge is necessary.

When a momentary power failure occurs in 110 VAC line 25 (momentary meaning for a time period less than the capacity of low voltage battery 27 to bridge the power failure), bi-directional connection 67, battery charge/discharge network 65, and bi-directional connection 66 operate to maintain low voltage line 26 at 24 VDC by using energy stored in battery 27. In this case, no period of inoperativeness of CST 12 is experienced. Later, when 110 VAC power is restored, it is likely that bi-directional connection 66, battery charge/discharge network 65, and bi-directional connection 67 will operated to recharge battery 27.

When the power failure of 110 VAC line 25 results in a considerable expenditure of the charge-energy that is within low voltage battery 27, battery state indictor 30 visually indicates a need to replace that particular battery 27, for example, battery state indicator emits red-light. In this case, it may be necessary to swap two batteries 27, the low-charge battery 27 being replaced by a high-charge battery 27. In this case a short period of inoperativeness of CST 12 is experienced. However, since CST 12 does not include an no/off function, all that is necessary to restore CST 12 to its operative condition is to plug-in the high-charge battery 27.

What is claimed is:

1. A telecommunications system, comprising:
a customer service terminal having a digital signal-input, a low voltage DC power-input, a plurality of analog signal-outputs, and at least one digital signal-output;
a digital subscriber line connected to said digital signal-input;
a plurality of analog devices, one analog device being connected to each one of said plurality of analog signal-outputs;
a low voltage DC power supply having a high voltage AC input connected to a high voltage AC power line, and having a low voltage DC output connected to said low voltage DC power-input;
a low voltage rechargeable battery pack forming a manually-removable portion of said low voltage DC power supply;
said low voltage DC power supply being operable to utilize said low voltage battery pack to maintain said low voltage DC power input to said low voltage DC power-input of said customer service terminal upon failure of said high voltage AC line connected to said high voltage AC input of said low voltage DC power supply;
a first indicator forming a portion of said low voltage DC power supply to indicate failure of said high voltage AC power line;
a second indicator forming a portion of said low voltage DC power supply to indicate a state of charge of said battery pack; and
said low voltage DC power supply being constructed and arranged to facilitate manual removal of a discharged low voltage battery pack, and manual installation of a charged low voltage battery pack, without interrupting operation of said customer service terminal, so long as said first indicator indicates a lack of failure of said high voltage AC line.

2. The telecommunications system of claim 1 wherein a current capacity of said low voltage battery pack operates to maintain operation of said customer service terminal in the event of failure of said high voltage AC line for a time period as long as eight hours.

3. The telecommunications system of claim 1 wherein said digital subscriber line is an xDSL.

4. The telecommunications system of claim 3 wherein a current capacity of said low voltage battery pack operates to maintain operation of said customer service terminal in the event of failure of said high voltage AC line for a time period as long as eight hours.

5. The telecommunications system of claim 4 wherein said xDSL line is a SDSL line.

6. The telecommunications system of claim 1 wherein said customer service terminal remains continuously operative so long as a low voltage DC is continuously applied to said low voltage DC power-input;
such that removal of a discharged low voltage battery pack and installation of a charged low voltage battery pack in the presence of said first indicator indicating failure of said high voltage AC power line results in a period of inoperativeness of said customer service terminal that is equal in length to the time that it takes to remove said discharged low voltage battery pack and then install said charged low voltage battery pack.

7. A telecommunications system, comprising:
a customer service terminal having a digital signal-input, a low voltage DC power-input, a plurality of analog signal-outputs, and at least one digital signal-output;
a digital subscriber line connected to said digital signal-input;
a plurality of analog devices, one analog device being connected to each one of said plurality of analog signal-outputs;
at least one digital device connected to said at least one digital signal-output;
a low voltage DC power supply having,
a high voltage AC input connected to a high voltage AC power line,
an AC-to-DC rectification network having an AC input connected to said high voltage AC input and having a high voltage DC output,
a pulse width modulating DC-to-DC converter having an input connected to said high voltage DC output of said AC-to-DC rectification network, and a low voltage DC output connected to said low voltage DC power-input of said customer service terminal,
a control loop connected to said low voltage DC output of said pulse width modulating DC-to-DC converter and responsive to DC energy demands of said customer service terminal, and connected in controlling relation to said pulse width modulating DC-to-DC converter;
a low voltage rechargeable battery pack connected to said pulse width modulating DC-to-DC converter for charging said low voltage rechargeable battery pack and for maintaining said low voltage DC power input to said low voltage DC power-input of said customer service terminal upon failure of said high voltage AC line connected to said high voltage AC input of said low voltage DC power supply; and
said low voltage DC power supply being constructed and arranged to facilitate manual removal of a discharged low voltage battery pack, and manual installation of a charged low voltage battery pack without interrupting operation of said customer service terminal.

8. The telecommunications system of claim 7 including:
a first indicator forming a portion of said low voltage DC power supply for indicating failure of said high voltage AC power line;
a second indicator forming a portion of said low voltage DC power supply for indicating a state of charge of said low voltage rechargeable battery pack.

9. The telecommunications system of claim 7 wherein:
a low voltage DC applied to said low voltage DC power-input of said customer service terminal is effective to maintain said customer service terminal operative in the absence of an on/off switch for said customer service terminal;
a current capacity of said low voltage rechargeable battery pack operates to maintain operation of said customer service terminal in the event of failure of said high voltage AC line for a relatively long time period; and.
wherein after such a relatively long time period said low voltage rechargeable battery pack can be replaced while rendering said customer service terminal inoperable for only the time interval needed to effect said replacement.

10. The telecommunications system of claim 9 wherein said current capacity of said low voltage rechargeable battery pack operates to maintain operation of said customer service terminal in the event of failure of said high voltage AC line for a time period as long as eight hours.

11. The telecommunications system of claim 10 wherein said digital subscriber line is an xDSL.

12. In a telecommunications system having a customer service terminal that is connected to receive telecommunication input from a XDSL and which provides output analog telephone service and output digital data service from said XDSL, said customer service terminal remaining operate so long as a low voltage DC is applied to a low voltage DC input thereof, a method for minimizing periods of inoperativeness of said customer service terminal, comprising:
providing a DC power supply having a high voltage AC input and a low voltage DC output;
connecting said low voltage DC out put of said DC power supply to said low voltage DC input of said customer service terminal;
providing a high voltage AC source;
connecting said high voltage AC input of said DC power source to said high voltage AC source;
providing a rechargeable low voltage battery;
connecting said rechargeable low battery to said DC power supply in a manner to apply a low voltage DC to said low voltage DC input of said customer service terminal upon failure of said high voltage AC source;
utilizing said DC power supply to charge said rechargeable low voltage battery when said high voltage AC source has not failed;
providing an indicator to visually indicate that a charge of said battery is low; and
swapping said low voltage battery for a fresh low voltage battery as a function of said visual indication.
